(19) United States
(12) Patent Application Publication
(10) Pub. No.: US 2007/0082119 A1
(43) Pub. Date: Apr. 12, 2007

(54) Cake mixture

(75) Inventors: Stephanie Blanche, Moos-Bankholzen (DE); Anders Ekberg, Bjuv (SE); Kurt Bloechlinger, Kemptthal (CH)

Correspondence Address: BELL, BOYD & LLOYD LLP, P.O. Box 1135, CHICAGO, IL, 60690, US

(73) Assignee: Nestec S.A., Vevey (CH)

(21) Appl. No.: 10/595,363

(22) PCT Filed: Apr. 1, 2004
(86) PCT No.: PCT/EP04/03464

§ 371 Date: Jul. 24, 2006

(30) Foreign Application Priority Data
Oct. 13, 2003 (EP) 03023035.3

(51) Int. Cl. A23G 3/00

(52) U.S. Cl. 426/660

(57) ABSTRACT

The present invention relates to a refrigerated fluid cake mixture that is suitable for making cakes of chocolate fondant type. The cake mixture according to the present invention is characterized by the use of fat in the form of discrete particles of fat that are solid at room temperature, distributed in the continuous mixture phase. The mixture thus keeps all its fluidity, including at the usual refrigeration temperatures at which the products may be stored for several weeks.

### BACKGROUND

The present patent application relates to a liquid or fluid mixture for the preparation of pastry desserts, for example of the chocolate fondant type.

Pastry desserts of the fondant type such as chocolate fondant are particularly appreciated by consumers and in particular by chocoholics. Specifically, this type of product is characterized by an exterior consisting of soft, more or less risen and airy cooked pastry, which may be crisp at the surface, surrounding in its entirety a fluid, runny or fondant interior or core. The pastry product thus obtained therefore has a fondant interior in that it appears to contain a soft filling that is more or less runny at room temperature and fluid at higher temperatures. This type of product is particularly appreciated on account of this contrast in texture between the softness of the outer dressing and the runniness of the interior consisting of a fluid or fondant chocolate mass rich in chocolate and fat such as butter. Usually, the outer dressing is more or less risen, depending on the amount of raising agent contained. Its outer surface is generally more or less crisp, as a function of the intensity and mode of cooking. The fondant core comprises a chocolate base garnished with a mass of fat that is soft but not liquid at room temperature, thus giving the finished product its creaminess and fondant nature.

This type of product is generally prepared extemporaneously by the consumer himself according to various recipes. In general, the various recipes comprise a large amount of chocolate with added fat—mainly butter—sugar, egg and flour being added to the whole. The addition of chemical raising agent is optional and is generally omitted. In practice, the preparation starts by melting and mixing the chocolate and fat, on the one hand; intimately mixing the sugar, flour and eggs, on the other, and finally mixing the two preparations together to form a uniform mixture. The mixture obtained may be poured either into a multi-well mold or into individual molds and then baked in a standard convection oven at a temperature of about 200° C., for example, for 10 to 30 minutes depending on the size of the molds used and the amount of mixture.

The product obtained, of cake type, has a cooked pastry exterior surrounding a chocolate-flavored fondant or runny core.

Such products are long and laborious to prepare on account of the various steps of melting of the chocolate and fat, followed by two mixing steps. In addition, such a preparation involves the use of a multitude of kitchenware and accessories, which constitutes an additional barrier to its implementation by consumers, whose lifestyle is less and less adapted to long and laborious culinary preparations.

Ready-cooked products are available on the market, but such products do not have the maximum organoleptic qualities of a freshly cooked product. The outer part of the pastry is often softened and soggy due to the long storage and, what is more, the interior is finally not very fondant but rather compact or, on the other hand, rather too airy and no longer resembles the desired product.

As an alternative, frozen uncooked pastry preparations are available to consumers, which, by direct cooking, allow products of the type described above to be prepared. However, such frozen products leave little room for creativity and involve no intervention by the consumer, who thus finds himself with a standardized product without any margin for maneuver as regards his participation in the making of the product. Specifically, even if the preparation of such products is perceived as a handicap, the standardization of mass-produced products offers only a partial answer. Thus, consumers are more and more inclined to use products whose preparation involves their participation. Thus, while having the advantages of a standardized industrial product, the consumer can then add his personal touch to the preparation of the product, therefore distinguishing it from mass-produced products, while at the same time minimizing the efforts and complications.

To this end, dehydrated premixtures are available on the market, which can be used for making mixtures by simple addition of a given amount of liquid source and/or of fat and/or of chocolate, followed by mixing. These products generally keep without any problem, but they do not make it possible to dispense with the steps of melting of the chocolate and fat and, in any case, of mixing, which, as outlined above, are often perceived by the consumer as being obstacles.

Ready-to-cook liquid or fluid mixtures, which are refrigerated or stable at room temperature, have been described. These are mainly products that are conserved by using chemical preserving agents. For certain other products, the stability on storage is provided by means of a drastic reduction of the water activity (Aw) of the product to values of about 0.9 and below. The sweet nature of such products and of pastry products for the manufacture of which they are intended makes it possible easily to regulate this Aw by adding large amounts of sugar serving simultaneously as a taste ingredient, a filler and an agent for reducing the Aw. It is very important for such products to have as low a viscosity as possible in order to be able to be poured easily into a baking mold, not only at room temperature but also at the usual refrigeration temperatures. This viscosity should also be compatible with the adequate formulation of said mixture, in particular the adequate amount of agents for reducing the Aw that also contribute towards increasing the viscosity.

In the particular case of products of the chocolate fondant type, during the domestic preparation of the mixture, the fats and the chocolate are melted and mixed with the other ingredients. The substantially high temperature of the mixture at this moment is such that its viscosity is compatible with the need to pour it easily.

However, on account of the amount of fats, in particular butter but also chocolate which itself constitutes an important source of fats that are solid at room temperature, the refrigeration of such a product results in solidification of these contained fats. The mixture thus refrigerated transforms into a compact block whose viscosity makes it very difficult or even impossible to pour. As a result, it was found to be impossible to obtain a fluid mixture intended for making fondant that has all the organoleptic qualities of a traditional product, such as chocolate fondant, and which has the particular feature of being able to be kept for several weeks at the usual refrigeration temperatures while at the same time maintaining this same fluidity that makes it able to be poured easily during its final use as soon as it is removed from the refrigerator. Specifically, the solution consisting in using fats that are fluid at refrigeration temperatures is such that the final cooked product has an outer pastry soaked with fat and having an oily feel and mouthfeel—which is very unpleasant.

### SUMMARY

One object of the present invention is thus to provide a liquid or fluid mixture that can be stored for several weeks in refrigerated form and that allows the preparation of pastry products of the fondant type by the simple action of pouring said mixture into a mold and cooking in a standard oven.

To this end, the present invention relates to a ready-to-use mixture that is fluid and stable for several weeks in refrigerated form, comprising a continuous mixture phase comprising flour, water and sugar, having an Aw of between 0.85 and 0.90, characterized in that it comprises at least one source of fat present in the form of discrete particles distributed in the continuous phase of said mixture.

In the rest of the present patent application the percentages are expressed on a weight basis, unless otherwise indicated.

Additional features and advantages are described herein, and will be apparent from, the following Detailed Description.

### DETAILED DESCRIPTION

The expression “discrete fat particles” means that the fat is present in the form of substantially distinct solid parts of material component that are visible to the naked eye and distributed in the continuous mixture phase.

Thus, and surprisingly, it has been observed that the fact of using all or some of the fat in the form of discrete particles distributed in the mixture rather than in diffuse and continuous form makes it possible to obtain a mixture whose fluidity is satisfactory to make it pourable. Thus, it was realized that when the fat is uniformly distributed, in a diffuse and continuous manner, the mixture loses a large proportion of its fluidity and thus becomes very difficult to pour or does not give the expected result, i.e. a cake of fondant type. Specifically, once refrigerated, this continuous fat solidifies and the mixture thus becomes very compact and hence very difficult to pour.

In contrast, and according to the main means of the present invention, all or some of the source of fat of the cake mixture according to the invention is in the form of discrete pieces/particles of fat distributed in the continuous mixture phase. Once refrigerated, the mixture according to the invention is fluid rather than being compact since the solid fat is not continuously and uniformly distributed and thus does not act as a cement. The mixture thus has all the fluidity necessary to be pourable.

In the context of the present invention, the “fluid” characteristic means that the mixture can be poured from its packaging into a mold easily, that is to say also that it can flow by itself without any excessive external constraint. To this end, the mixture according to the invention may be characterized by its Bostwick consistency—a method commonly used in the food industry.

For example, before performing the measurements, the liquid mixture is first placed at 8° C. until an equilibrium is reached. The measurements are performed in a chamber regulated at 8° C. The mixture is then poured into the first closed compartment of the “Bostwick Consistometer ” equipment, thus occupying a total volume of 5×5×3.8 cm. The test starts at the moment that this compartment is opened. Under the effect of gravity, the mixture flows into the second compartment (width 5 cm, length 24 cm, height ˜2.5 cm). This second compartment is graduated (0.5 cm increments), and the distance covered by the mixture is measured after 10, 20, 30 and 40 seconds. When the mixture flows producing a curvilinear surface, the longest distance is taken into account.

The following results are obtained:

Time (s)

| | 10 | 20 | 30 | 40 |
|---|---|---|---|---|
| Distance | 3-9 | 4-10 | 5-11 | 6-12 |
| (cm) | | | | (cm) |

Such behavior demonstrates flowability that is entirely compatible with the desired aim. Specifically, this consistency is obtained at about 8° C., the usual temperature at which a mixture of this type is used.

The source of fat may be a fat that is solid at the usual refrigeration temperatures and preferentially solid at the usual room temperatures. The term “solid at room temperature” means that the fat has an SFC (Solid Fat Content) of from about 15% to 80%, preferentially from about 20% to 60% and even more preferentially from about 20% to 45% at about 20° C. A suitable source of fat for the present invention may thus be chosen from the group comprising: butter, cocoa butter, chocolate, cocoa butter substitutes, hydrogenated plant fats such as hydrogenated palm oil, used alone or as a mixture. Specifically, given the fat content of chocolate—from about 28% to 45%—chocolate is particularly suitable as a partial source of fat according to the invention. It goes without saying that, as in the case of a conventional recipe comprising a large proportion of butter, the source of fat represented by the chocolate may be replaced with butter or cocoa butter. The butter will then be at least partly in the form of discrete particles, or discrete pieces, of butter distributed in the continuous mass of fluid mixture. For cost reasons, a fat of cocoa butter substitute type such as a hydrogenated palm oil or a hydrogenated palm kernel oil may be preferred.

Preferentially, the source of fat in the form of discrete particles represents at least 60%, preferably at least 70%, more preferentially at least 80% and even more preferentially at least 90% or even at least 95% of the total fat contained in the ready-to-use mixture according to the present invention.

Specifically, the continuous mixture phase mainly comprising flour, water and sugar may also comprise traces originating from the flour or from the sources of fat such as non-defatted cocoa powder or egg powder, for example, or even an oil that is liquid at room temperature, and as such the fat is also included in the ready-to-use mixture according to the present invention in a uniformly distributed form rather than in the form of particles. However, this uniformly distributed fat represents only a small proportion of the total fat of the ready-to-use mixture according to the present invention.

The present invention also relates to the use of a source of fat in the form of discrete particles distributed in a continuous phase of refrigerated fluid mixture comprising flour, water and sugar, characterized in that the total fat content of the mixture including the particles is from about 12% to 25%, preferentially from 15% to 20% and even more preferentially from 16% to 18%, to ensure the fluidity required for said mixture to flow during transfer from its packaging into a baking mold. Preferentially, the fat in the form of particles represents at least 60%, preferentially at least 70%, more preferentially at least 80% and even more preferentially at least 90%, or even at least 95% of the total fat of the finished product of ready-to-use fluid mixture.

The size of the discrete particles of source of fat is in a range that can readily be determined by a person skilled in the art so as to allow flow. Thus, the particles should not be too coarse, so as to be able not only to flow but also to prevent excessive sedimentation during storage and also during cooking. In contrast, it is not desirable for the particles to be too small, so as not to form a network that opposes the flow of the mixture. In addition, in the event of a heat shock, particles that are too small run the risk of at least partially melting and thus of reforming a continuous network on cooling, this network forming a cement that opposes or at least limits flow. Finally, the use of excessively small particles is difficult and intricate.

The reason for this is that, during the preparation of the mixture, the incorporation of the particles of source of fat with the mixture requires intimate mixing, which may lead to a release of heat responsible for the melting—even partial—of the fat, which, once cooled, will act as a cement and will lead to a compact product rather than a fluid product.

Thus, the particles of source of fat of the mixture according to the present invention have a mean size of from about 0.1 to about 4 mm, preferentially from 0.5 to 3 mm and even more preferentially from 0.5 to 2 mm. It is clear that the shape of the particles is not uniformly cylindrical or cubic and the size indicated above corresponds to the mean cross section for particles of irregular shape. Thus, the particles may be in the form of irregular parallelepipeds, cubes or spheres or in the form of flakes, for example. It is thus easier to speak of a mean volume of the particles of source of fat and the mean volume of such particles is in a range from about 0.01 mm³ to 80 mm³, preferentially from 0.01 to 40 mm³, more preferentially from 0.1 to 20 mm³ and even more preferentially from 0.1 to 10 mm³ or even of about 1 mm³.

Given that chocolate may constitute a source of fat within the meaning of the present invention, it is entirely envisageable to provide chocolate pieces larger than the mean size indicated above. Specifically, larger chocolate pieces may contribute toward obtaining the inclusion of fondant chocolate in the cake obtained after cooking.

It has thus been observed, surprisingly, that the provision of a source of fat in the form of discrete particles distributed in the continuous phase of a refrigerated mixture comprising flour, water and sugar, in accordance with the invention, makes it possible not only to conserve the fluidity of said mixture at temperatures corresponding to the usual refrigeration temperatures, but also to obtain a cooked pastry product that has all the desired organoleptic qualities.

Specifically, the mixture according to the present invention may be poured directly into a mold as soon as it is taken out of the refrigerator and baked in a standard oven to give a cake that has all the characteristics of a fondant. Thus, the cake obtained has a cooked pastry exterior and a fondant interior predominantly comprising chocolate-flavored fat that is runny or fondant, according to the temperature. Specifically, if the cake is cut shortly after it is taken out of the oven, the hot interior is runny, whereas, if it is left to cool, the source of fat solidifies partially on cooling and thus becomes soft and fondant in the mouth. Alternatively, if the cooking of the mixture is relatively light, the interior that is liquid after leaving the oven will remain liquid after cooling.

It is clear that, in the preferential context of the present invention concerning cakes of chocolate fondant type, the main sources of fat are represented by chocolate, butter, cocoa butter or any other fat that is solid at room temperature, used alone or as a mixture. Thus, the source of fat in the form of discrete particles may consist of chocolate grains, granules or chips and/or of compound and/or of butter and/or of any fat that is solid at room temperature, for example. Compound is a product composed of defatted cocoa powder and of plant fat, which has properties similar to those of cocoa butter. Alternatively, it may be envisioned to use butter with added defatted cocoa powder as source of fat in the chocolate fondant application.

The continuous fluid mixture phase comprises a conventional fluid mixture comprising flour, sugar and water. The total amount of water in the mixture according to the invention is from about 20% to 40%, preferentially from 25% to 35% and even more preferentially about 30%, relative to the weight of the final product. The mixture may also comprise a texture improver of the egg product type, such as whole egg, egg yellow or egg white, provided in liquid or dehydrated form. An emulsifier may be added, for instance one or more monoglycerides and diglycerides. The mixture may contain flavorings, but also colorings. In particular, the mixture of the continuous phase may contain cocoa powder to reinforce the chocolate flavor of the final product and also to give the appropriate dark color of a chocolate fondant.

The chocolate flavor may also be reinforced by any means known to those skilled in the art. Yeast extracts, polycyclic lactones, natural and/or artificial chocolate flavorings or L-glutamate may be used, for example.

Although the present invention relates to a pastry product of compact and sparingly airy fondant type, the mixture according to the present invention may comprise an amount of raising agent of between 0 and 2%. Raising agents for pastry cookery are commercially available in ready-to-use form and are generally composed of sodium diphosphate and carbonate.

The present invention also relates to a process for manufacturing a fluid cake mixture that is stable for several weeks in refrigerated form, having an Aw of between 0.85 and 0.9, comprising the following steps:

mixing together a source of flour, a source or sugar and a source of water and adding a source of fat that is solid at room temperature,

mixing while maintaining the temperature of the mixture at a value below the melting point of the fat, until a fluid mixture is obtained in which the source of fat that is solid at room temperature is in the form of discrete particles distributed in the continuous mixture phase.

The flour used may be any type of cereal flour, for instance a flour of 55 or 45 type.

The sugar used may be any food sugar such as sucrose, fructose or glucose. A suitable sugar is crystallized or powdered sucrose.

Finally, the present invention relates to a quick and simple method for making a cake of fondant type, comprising the steps of:

providing a fluid cake mixture comprising water, flour and sugar, which is stable for several weeks in refrigerated form, having an Aw of between 0.85 and 0.90, characterized in that it comprises at least one source of fat present in the form of discrete particles distributed in the mixture,

pouring said mixture into at least one mold,

baking the mixture thus poured,

obtaining a baked cake comprising a fat-based fondant interior.

### EXAMPLE

The following ingredients are added into a Hobart mixer, and the whole is mixed at a temperature of about 20° C.:

Flour: 7 kg

Sugar: 18 kg

Water: 13 liters

Plant fat (such as cocoa butter substitute) in 100 g cubes: 5 kg

Coarsely grated chocolate (1 to 2 mm in diameter): 5 kg Egg powder: 2.5 kg

The whole is mixed and kneaded for 3 minutes at slow speed until a mixture is obtained in which the fat is in the form of uniformly distributed discrete inclusions distributed in the continuous fluid mixture phase.

The mixture thus obtained is fluid enough to be poured into supple plastic bags in a proportion of 400 g per package, which are then heat-sealed under a nitrogen atmosphere and cooled to about 5° C.

The packaged products thus refrigerated are stored for 4 weeks at 5° C. and then used for making a cake.

The package is opened, the mixture is then poured effortlessly into a mold 23 cm in diameter and the whole is baked in a convection oven at a temperature of 200° C. for 15 minutes.

Once cooled to room temperature, the cake obtained has a baked pastry exterior containing a chocolate-flavored fondant interior.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A ready-to-use mixture that is fluid and stable for several weeks in refrigerated form, comprising a continuous mixture phase comprising flour, water and sugar, having an Aw of between 0.85 and 0.90, and at least one source of fat present in the form of discrete particles distributed in the continuous phase of said mixture.

2. The mixture as claimed in claim 1, wherein the source of fat is selected from the group consisting of: butter, cocoa butter, chocolate, cocoa butter substitutes, and hydrogenated plant fats alone or as a mixture.

3. The mixture as claimed in claim 1, wherein the source of fat in the form of discrete particles represents at least 60%, of the total fat contained in the fluid ready-to-use mixture according to the present invention.

4. A method for preparing a mixture comprising using a source of fat in the form of discrete particles distributed in a continuous phase of refrigerated fluid mixture comprising flour, water and sugar, to ensure a fluidity required for the mixture to flow at refrigerated temperature during transfer from its packaging into a baking mold.

5. The method as claimed in claim 4, wherein the total fat content of the mixture including the particles is from about 12% to 25%.

6. The method as claimed in claim 4, wherein the fat in the form of particles represents at least 60%, of the total fat of the finished product of ready-to-use fluid mixture.

7. A method for making a cake of fondant type comprising the steps of:
providing a fluid cake mixture comprising water, flour and sugar, which is stable for several weeks in refrigerated form, having an Aw of between 0.85 and 0.90, and at least one source of fat present in the form of discrete particles distributed in the mixture,
pouring the mixture into at least one mold,
baking the mixture thus poured, and
obtaining a baked cake comprising a fat-based fondant interior.

8. The mixture as claimed in claim 2 wherein the source of fat is hydrogenated palm oil.

9. The mixture as claimed in claim 1 wherein the source of fat in the form of discrete particles represents at least 70% of the total fat contained in the fluid ready-to-use mixture according to the present invention.

10. The mixture as claimed in claim 1 wherein the source of fat in the form of discrete particles represents at least 80% of the total fat contained in the fluid ready-to-use mixture according to the present invention.

11. The mixture as claimed in claim 1 wherein the source of fat in the form of discrete particles represents at least 90% of the total fat contained in the fluid ready-to-use mixture according to the present invention.

12. The mixture as claimed in claim 1 wherein the source of fat in the form of discrete particles represents at least 95% of the total fat contained in the fluid ready-to-use mixture according to the present invention.

13. The method as claimed in claim 4, wherein the total fat content of the mixture including the particles is from about 15% to 20%.

14. The method as claimed in claim 4, wherein the total fat content of the mixture including the particles is from about 16% to 18%.

15. The method as claimed in claim 4 wherein the source of fat in the form of discrete particles represents at least 70% of the total fat contained in the fluid ready-to-use mixture according to the present invention.

16. The method as claimed in claim 4 wherein the source of fat in the form of discrete particles represents at least 80% of the total fat contained in the fluid ready-to-use mixture according to the present invention.

17. The method as claimed in claim 4 wherein the source of fat in the form of discrete particles represents at least 90% of the total fat contained in the fluid ready-to-use mixture according to the present invention.

18. The method as claimed in claim 4 wherein the source of fat in the form of discrete particles represents at least 95% of the total fat contained in the fluid ready-to-use mixture according to the present invention.
